(19) United States
(12) Patent Application Publication
(10) Pub. No.: US 2021/0374198 A1
(43) Pub. Date: Dec. 2, 2021

(54) INTERACTIVE SUGGESTIONS FOR DIRECTED CONTENT COPY USING A DEEP LEARNING MODEL

(71) Applicant: Microsoft Technology Licensing, LLC, Redmond, WA (US)

(72) Inventors: Rui ZHOU, Bellevue, WA (US); Amit Kumar YADAV, Woodinville, WA (US); Xuefei NING, Kirkland, WA (US); Sumeet Sunil AGRAWAL, Redmond, WA (US); Weiqing TU, Bellevue, WA (US); Biao JIANG, Sammamish, WA (US)

(73) Assignee: Microsoft Technology Licensing, LLC, Redmond, WA (US)

(21) Appl. No.: 16/888,796

(22) Filed: May 31, 2020

(51) Int. Cl. G06F 16/958; G06F 16/955; G06F 16/951; G06N 3/08

(52) U.S. Cl. CPC G06F 16/958; G06N 3/08; G06F 16/951; G06F 16/9566

(57) ABSTRACT

The present disclosure relates to systems and methods to generate, in real-time, copy suggestions for a directed content for interactive design operations of copy. A generative deep learning model encodes content of the website into an embedded form with context of the content. The model decodes the encoded form of the content based on the user input to generate copy suggestions. Used in conjunction with an interactive copy design client, the present disclosure interactively receives user input to iteratively modify the copy suggestions in real-time while validating a quality of the copy suggestions. The real-time, interactive design of copy for the directed content improves timing, accuracy, and productivity of the design operations.

### BACKGROUND

Content directing consumers to websites, organizations, products and services has become commonplace on the Internet. Placing directed content on Internet search results pages, for example, has become a popular way to help consumers identify organizations, products, and services that meet their interest. The popularity of such directed content has resulted in increasing need to automatically and interactively provide high quality copy (e.g. descriptive text, creative, and catch) in real-time. The intent behind providing the high quality copy is to capture the users' attention and to encourage more users to visit websites that are the subject of the directed content. However, creating high quality copy requires up-to-date knowledge about characteristics of the organization, products, and services that are the subject of the directed content. In addition, accurate understandings about the latest promotional offerings and business terms and conditions about the products and services may be helpful. Furthermore, copy should be free from expressions that may be offensive or inappropriate based on regulations and common practices. Prior systems for providing directed content copy were not interactive or available in real-time.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

According to the present disclosure, the above and other issues are resolved by using a deep learning model that encodes website content while embedding context of the website content and decodes the encoded content into suggestions of copy text for directed content. In particular, to address the issues identified above, the present systems and methods provide a user interface to interactively receive information about a website or a Uniform Resource Locator (URL) of a landing page of a website, for example, that is the subject of directed content. The user interface further enables a user to begin to input copy for the directed content. In response, the present systems and methods interactively provide suggestions for the remainder of the directed content copy in real time based on the text input and the deep learning model based on the website.

Systems and methods of generating a copy suggestion for directed content for a website comprise generating a preliminary copy suggestion based on a deep learning model, wherein the deep learning model is generated using content of a website. Input is received from a user to be included in the directed content. The preliminary copy suggestion is modified based on the input from the user and the deep learning model to generate a modified copy suggestion. The modified copy suggestion is validated, and if valid, provided to the user. Multiple preliminary copy suggestions may be provided for selection by the user. In aspects, validating the modified copy suggestion determines whether it will be made available to be used in the directed content. For example, validating may include determining that the modified copy suggestion is invalid when one or more words in the modified copy suggestion match a word in a dictionary of disapproved words, the modified copy suggestion contradicts the content of the website, and/or the modified copy suggestion fails to meet a grammar requirement. In aspects, validating the modified copy suggestion includes determining whether the modified copy suggestion is relevant to a context of the content of the website. In some aspects, notice is provided to the user when the modified copy suggestion is invalid or the user input is rejected.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for interactively providing suggestions on directed content copy in accordance to aspects of the present disclosure.

FIG. 2 illustrates an example method of interactively generating suggestions on directed content copy in accordance with aspects of the present disclosure.

FIGS. 3A-3B illustrate an example method of interactively providing suggestions on directed content copy according to aspects of the present disclosure.

FIG. 4 illustrates an example timing chart for interactively providing suggestions on directed content copy in accordance with aspects of the present disclosure.

FIGS. 5A-B illustrate examples of screens of a web browser in accordance with aspects of the present disclosure.

FIGS. 6A-D illustrate examples of an interactive directed content copy design client in accordance with aspects of the present disclosure.

FIG. 7 is a block diagram illustrating example physical components of a computing device with which aspects of the disclosure may be practiced.

FIG. 8A is a simplified diagram of a mobile computing device with which aspects of the present disclosure may be practiced.

FIG. 8B is another simplified block diagram of a mobile computing device with which aspects of the present disclosure may be practiced.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure relates to systems and methods for generating, in real-time, suggestions for copy for directed content using deep learning models. Directed content is content directing users to an organization, a website, a product, or a service that may be of interest to such users. An advertisement is an example of directed content. Directed content has become an important part of the Internet and Internet websites. In aspects, web search service providers may simultaneously place the directed content alongside search results of the web. This way, the prospective customers may select the directed content by seeing it placed next to results of the web searched by the prospective customers.

Directed content often contains copy and image(s). Copy is the text portion of the directed content. Directed content usually also contains one or more links to take the prospective customers to landing pages of websites for the items and services in business. One purpose of copy is to capture the attention of end users or prospective customers out of many other directed contents. Good copy persuades the end users or the prospective customers to select the directed content and even to select links within the directed content.

The task of designing copy is complex. Designing persuasive copy may require specialized skills of wordsmithing. Further, it often requires a detailed understanding of the item or service to convey, accurate understanding of promotion, and creativity to use expressions that capture attention, for example, and do not offend. An issue arises when business owners or directed content providers do not have the skills to perform the task. The present disclosure addresses the issues of automatically designing effective copy for directed content by providing interactive user interface on a client while generating in real time suggestions of copy on a server based on a deep learning model.

The server attains an understanding of web content based on content of a landing page of the website, which may contain subject matter for directed content, such as an organization, a product, or a service to be advertised. The server receives location information or a Uniform Resource Locator (URL), for example, of the landing page from an interactive copy design client. The server extracts content of the landing page and other pages that relate to the landing page by performing web crawling in real-time or near real-time. Featurizing of the received web content may include decomposing texts in the received web content in the Hyper Text Markup Language (HTML) into a set of words of texts. The featurizing operation further determines features of respective groups of words by generating a vector form of the set of words based on linguistic features. The server uses an encoder portion of a deep learning model to embed the received web content as provided in the featurized format. The encoder captures contextual understanding of the items (or services) in embedded content data as a part of the deep learning model.

The server attains the understanding of persuasive copy for the items (or services) by using a decoder of the deep learning model. The decoder receives the encoded content data with embedded contexts of the content from the encoder and generates preliminary suggestions of copy for the items (or services). The decoder receives text input as at least a portion of a candidate copy from the Directed content provider from the interactive copy design client. Here, the expressions designing, editing, and modifying the copy may be used interchangeably. The text input may comprise one or more words, which the Directed content provider inputs while exploring a new copy or editing suggested copy. The decoder evaluates the received text input to determine a level or a probability of relevance among the received input, the web content, and the preliminary suggestions of copy.

In some other aspects, the decoder re-evaluates and updates the preliminary suggestions of copy as a user input with a new text input is received in addition to text input that has already been received. The advertiser may continue typing in words in a text input field of the interactive copy design client for example. The encoder evaluates the new text input to determine a level or a probability of relevance of the new text input against the web content and the text input that have been received before the new text input is received. Performance of updating the preliminary suggestions of copy improves by limiting the scope of the compare operations to the new text input against the web content and the text that has already been received. Based on the relevance, the decoder updates the preliminary suggestions of copy.

The server validates the preliminary suggestions of copy through post-processing. The post-processing outputs suggestions of copy for the Directed content providers. The post-process includes, but is not limited to validating and filtering the preliminary suggestions of copy based on the following four aspects. A first validation may be based on words that are appropriate for use in copy. A second validation relates to accuracy of the copy based on the content of the landing page of the items (or services). A third validation relates to relevancy of the copy to the Directed content providers' business context. A fourth validation is based on grammar and linguistics of the copy.

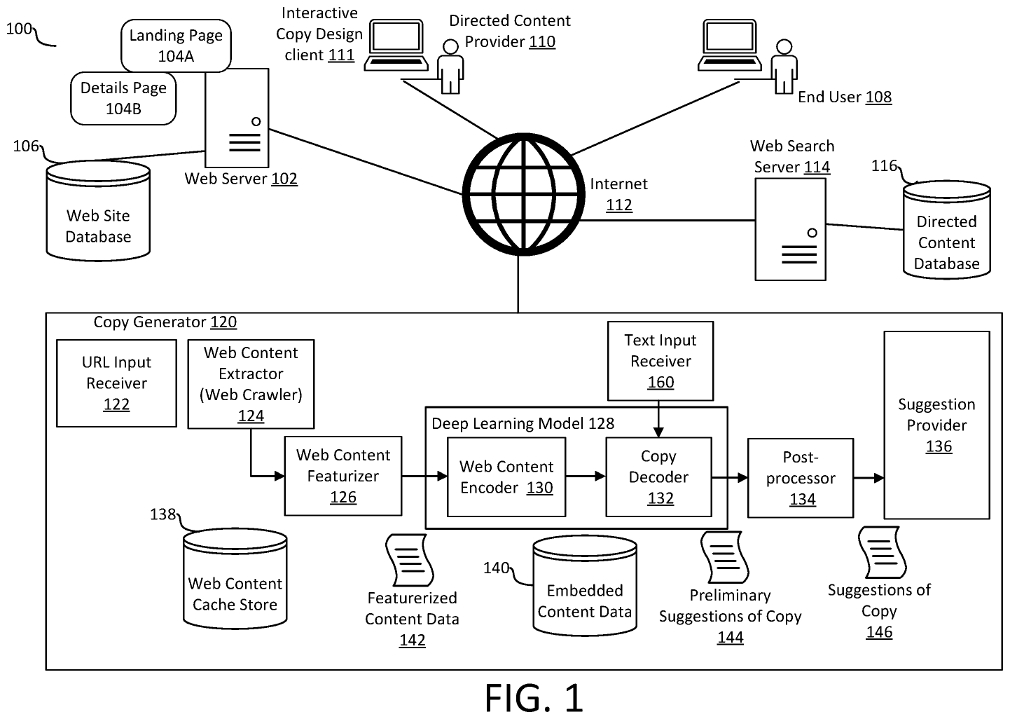

FIG. 1 illustrates an overview of an example system for interactively providing suggestions for copy for directed content in accordance with aspects of the present disclosure. System 100 may represent a system for interactively editing copy while dynamically updating suggestions of the copy. In some aspects, directed content comprises one or more portions of copy in distinct parts of the directed content. The system 100 may distribute the directed content as a secondary content as a part of results of web search requests as a primary content. In some other aspects, copy may be a part of directed content in an email for distribution. Copy may be a part of any directed content provided over the network.

Web server 102 serves web content to requestors of the web content over a network, the Internet 112 for example. Web server 102 may comprise a landing page 104A for an item, a topic, a service, or any subject matter. Web server 102 provides the web content for the subject matter. The landing page 104A is an entry web page for the subject matter. In aspects, location information or URL of the landing page 104A may be provided to enable a requestor, an end user 108, or prospective customers to access the landing page 104A. In aspects, directed content for an item or a service may include the URL. Web server 102 may serve the web content of the landing page 104A in response to a request for web content with a URL. The landing page 104A may include a link to a details page 104B. The details page 104B is a web page that contains detailed information about the item or the service. In aspects, there may be more than one details page 104B. The web content may be described in a web format, an HTML format for example. The web server 102 may dynamically generate the web content based on information about the items or the services as stored in a website database 106.

End user 108 uses a client device to access information over the internet. End user 108 may be a customer or a prospective customer who may search for a website to learn about new items or services, sport shoes for sale, for example. End user 108 may use a personal computer, computing device, a mobile computing device, or other devices that are suitable for use as a client device. End user 108 may use a variety of applications, a web browser application for example, on the computing device. In some aspects, end user 108 may use a web search server 114 to transmit a query to search for a web site that provides information about golf shoes, for example. After transmitting the query, the computing device used by end user 108 may receive content for a web page that comprises a first content type and a second content type. The first content type comprises a set of search results. The second content type may be directed content. In aspects, the web browser may display web content for both the first content type and another web content in the second content type. In aspects, the end user 108 may select directed content and access a website for an item or a service of the directed content.

Directed content provider 110 determines copy for the directed content. Directed content provider 110 may use a computing device to access the web server 102 to update content of the landing page 104A and/or the details page 104B based on new promotion or campaigns to sell the items or services through the web server 102. Additionally or alternatively, directed content provider 110 may request placing directed content on results of web searches as the web search server 114 transmits the results to end user 108 and/or other computing devices. Directed content provider 110 may use an interactive copy design client 111 to design copy for the directed content. Interactive copy design client 111 communicates with copy generator 120 to provide suggestions for copy. Interactive ad design client 111 provides an interactive user interface to directed content provider 110 to create, edit, and finalize copy. Directed content with the finalized copy may be sent to web search server 114. Web search server 114 registers the finalized copy in directed content database 116.

Web search server 114 searches for websites in response to a web search query that web search server 114 receives from end user 108. In aspects, web search server 114 generates a web search result page that include results of a web search. Web search server 114 connects to directed content database 116, which contains the content for directed content. Each piece of directed content comprises one or more copy. In generating a web search results page, web search server 114 may retrieve one or more pieces of directed content. The retrieved one or more pieces of directed content are relevant in contexts and semantics to the web search query. Web search server 114 may place the one or more pieces of directed content with respective copy on the web search results page. Web search server 114 transmits the generated web search results page that contains the directed content. In aspects, directed content provider 110 approves a draft directed content before inserting the directed content data into directed content database 116.

Copy generator 120 generates suggestions for copy. In aspects, copy generator 120 communicates with interactive copy design client 111 used by directed content provider 110. In particular, copy generator 120 receives input data from interactive copy design client 111. Copy generator 120 uses the input data to provide one or more suggestions of copy.

URL input receiver 122 receives an URL input from interactive copy design client 111. Directed content provider 110 may enter the URL input to start receiving suggestions for copy on an organization, an item or a service. The URL may specify a landing page of the website or an entrance page of the website about the item or the service.

Web content extractor 124 (e.g., web crawler or web content retriever) extracts content of a web page or a web site as specified by the received URL input. Web content extractor 124 requests content of a web page based on the received URL input. The received URL input may point to landing page 104A of web server 102, for example. Web content extractor 124 receives the content of the landing page 104A from web server 102. In some aspects, web content extractor 124 may extract content of one or more web pages or a details page 104B, for example, which are traversable from landing page 104A. In some other aspects, web content extractor 124 may request content of an entire website that includes the received URL input. Web content extractor 124 may perform content extraction in a manner that is similar to web crawling. In some other aspects, web content extractor 124 may request for web content and receive the web content using web protocols (e.g., Hypertext Transfer Protocol (HTTP)). Web content extractor 124 stores the extracted web content in web content cache store 138. The web content may be in an HTML format. In yet some other aspects, web content extractor 124 may extract the latest content of a web page or a website as specified by the received URL input. Web content extractor 124 may use a web push notification from the website as a trigger to update the extracted content for example.

Web content featurizer 126 featurizes the extracted web content. Featurizing the web content may include removing HTML mark-up tags from the web content. Web content featurizer 126 decomposes sentence texts into groups of words, analyzes each group of words in the sentences, and determines features for respective groups of words in the web content. In some aspects, web content featurizer 126 identifies features of the web content. Web content featurizer 126 outputs featurized content data 142. Featurized content data 142 may be an input to web content encoder 130 of a deep learning model 128.

Deep learning model 128 captures understanding about the web page specified to the URL input receiver 122. Deep learning model 128 also captures understanding about copy based on content of the landing page 104A, which may relate to an organization, an item, or a service. Deep learning model 128 generates suggestions (or preliminary suggestions 144) for copy. Deep learning model 128 comprises web content encoder 130 and copy decoder 132. In some aspects, deep learning generative models may be used to read textual information from the landing page and generate suggestions of copy.

In some aspects, the deep learning model may be trained using distinct types of training data for the encoder and the decoder portions. Web content encoder 130 may be trained based on key phrases and features, a title and a body for example, of a set of sample websites. The training data for the web content encoder 130 may comprise 5.5 million data points, for example. Copy decoder 132 may be trained using a sample collection of copy. The training data for copy decoder 132 may comprise eleven million data points, for example. The training data may further comprise paired data of a sample and a reference data of copy.

Web content encoder 130 takes featurized content data 142 of the landing page 104A as an input and generates embedded content data 140. In aspects, web content encoder 130 may be based on a pre-trained natural language representation model, Bidirectional Encoder Representations from Transformers (BERT) and a robustly optimized BERT pretraining approach (RoBERTa), for example. By embedding contexts of landing page 104A into the featurized content data 142 of web content data 140, embedded content data 140 captures an understanding the website, organization, the item, or the service to be advertised by the copy in the deep learning model 128.

Copy decoder 132 may receive the embedded content data 140 as an input. Copy decoder 132 decodes embedded content data 140 and generates one or more preliminary suggestions 144 of copy. In aspects, copy decoder 132 may be based on a transformer-based language model, which predicts subsequent words of copy based on the existing words plus its understanding the information from the landing page. In aspects, copy decoder 132 may be based on Generative Pre-trained Transformer 2 (GPT-2), for example. GPT-2 uses auto-regressive, transformer decoder blocks to iteratively suggest subsequent words (or tokens) to accurately generate preliminary suggestions 144 of copy for the website, the organization, the item, or the service.

Copy decoder 132 evaluates one or more words and determines a probability of the one or more words being relevant to a combination of content of the landing page 104A based on embedded content data 140 and preliminary suggestions 144 of copy. This operation may be called a decoder replay. Copy decoder 132 determines whether a text input received from interactive copy design client 111 is relevant enough to generate preliminary suggestions 144 of copy. When copy decoder 132 determines that the received text input has the probability of relevance below a predetermined threshold, copy generator 120 may provide no suggestion of copy to interactive copy design client 111. Otherwise, copy decoder 132 outputs a set of preliminary suggestions of copy.

Post-processor 134 processes the set of preliminary suggestions 144 of copy to output a set of suggestions of copy. The post-process includes, but is not limited to, validating and filtering the preliminary suggestions 144 of copy based on the following four aspects. A first validation may be based on words that are appropriate for use in copy. A second validation relates to accuracy of the copy based on the content of the landing page. A third validation relates to relevancy of the copy to the directed content provider's business context. A fourth validation is based on grammar and linguistics of the copy. Post-processor 134 outputs a set of suggestions of copy 146 by removing one or more preliminary suggestions 144 that fail the series of validations. In some aspects, post-processor 134 generates a likelihood of the preliminary suggestion 144 of copy being valid to be included as the set of suggestions of copy 146.

Suggestion provider 136 provides the set of suggestions of copy 146 to interactive copy design client 111. In aspects, suggestion provider 136 receives sets of suggestions of copy from more than one generator of suggestions. In some aspects, more than one deep learning model may provide suggestions. Suggestion provider 136 may aggregate suggestions and/or rank suggestions before transmitting the aggregated suggestions to interactive copy design client 111. In some aspects, suggestion provider 136 may provide the set of suggestions of copy 146 when post-processor 134 determines the likelihood that the set of suggestions of copy 146 is valid.

Text input receiver 160 receives text input from interactive copy design client 111 over the Internet 112. The text input is the same as or based on the text that directed content provider 110 enters on interactive copy design client 111 or as the directed content provider 110 edits a suggestion of copy. The text input may comprise one or more words. The text input may be a part of copy.

As should be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

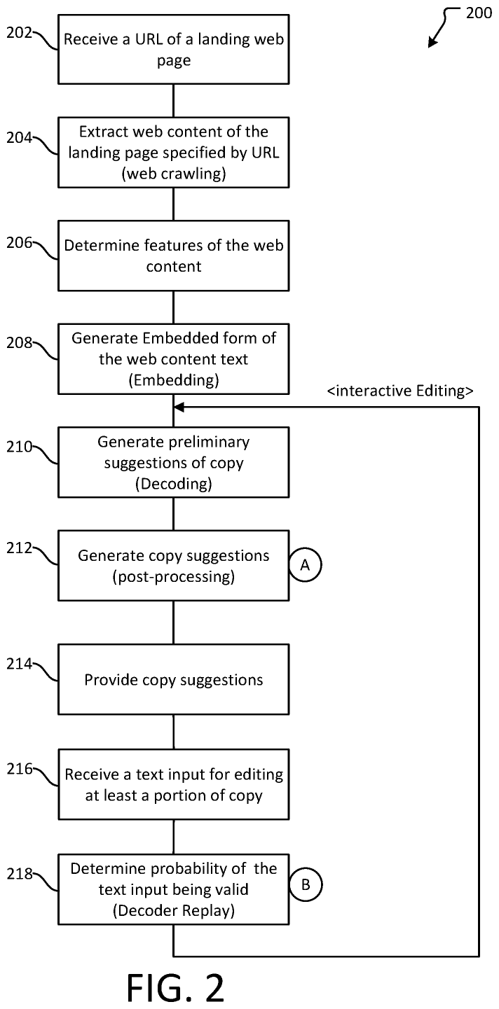

FIG. 2 illustrates an example method of interactively generating suggestions on directed content in accordance with aspects of the present disclosure.

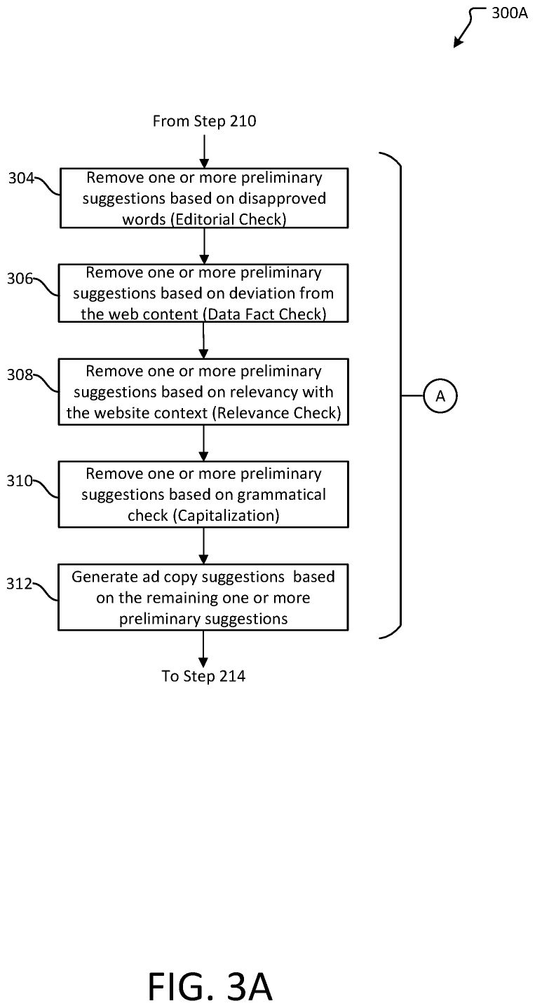

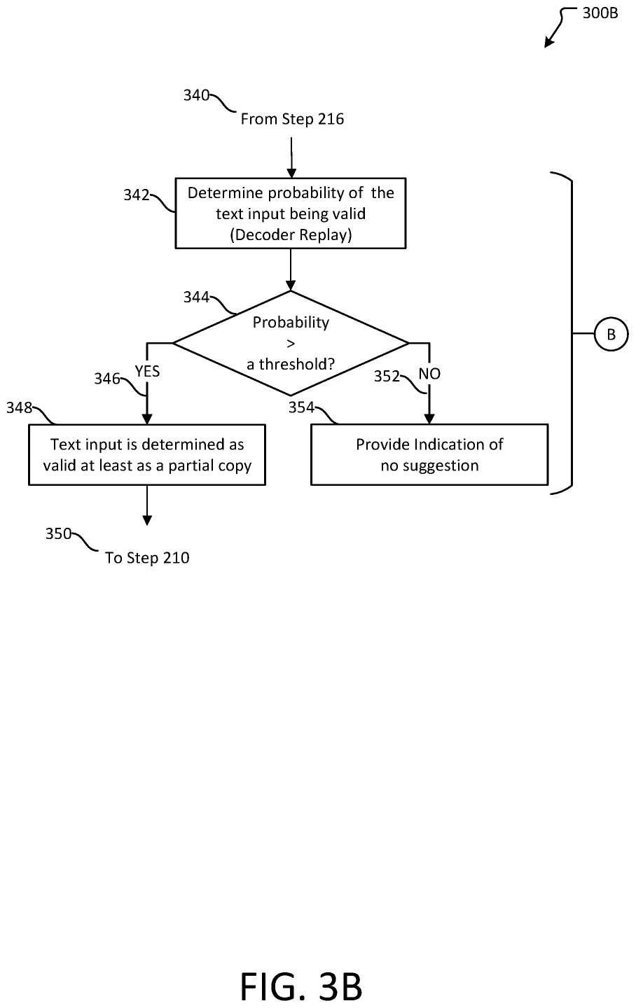

A general order of the operations for the method 200 is shown in FIG. 2. Generally, the method 200 begins with receive operation 202 and takes recurring operations after a determine operation 218. The method 200 may include more or fewer steps or may arrange the order of the steps differently than those shown in FIG. 2. The method 200 can be executed as a set of computer-executable instructions executed by a computer system and encoded or stored on a computer readable medium. Further, the method 200 can be performed by gates or circuits associated with a processor, an ASIC, an FPGA, a SOC or other hardware device. Hereinafter, the method 200 shall be explained with reference to the systems, components, devices, modules, software, data structures, data characteristic representations, signaling diagrams, methods, etc., described in conjunction with FIGS. 1, 3A-B, 4, 5A-B, 6A-D, 7, and 8A-B.

Receive operation 202 receives a URL of a landing page, landing page 104A in FIG. 1, for example. The URL points to a web page that contains web content about an item (or a website, a service, or an organization, collectively referred to as an “item”). The web content describes the item for which copy is needed.

Extract operation 204 extracts web content of the landing page 104A as specified by the URL. In aspects, extract operation 204 may extract more than web content of the landing page 104A but also web content of all the web pages that the landing page 104A links to. Extract operation 204 may use web crawling to capture the web content. In some other aspects, extract operation 204 may extract web content of all the web pages under the domain of the URL. The extent of extracting web content may be preconfigured. In aspects extracted web content may be stored in web content cache store 138 as shown in FIG. 1. The extracted web content may be in an HTML data format for example. Additionally or alternatively extract operation 204 may store extracted web content in a caching mechanism using e-memory for example. This way, recently extracted web content may be quickly accessible to help improve performance of generating or updating suggestions of copy when the user (e.g., direct content provider 110 in FIG. 1) interactively edits the copy.

Determine operation 206 determines features of the web content. Determine operation 206 converts the extracted web content from the HTML data format into a format that web content encoder of the deep learning model takes as an input. The web content may comprise texts from various parts of the web page (or the landing page 104A in FIG. 1): a page title, meta descriptions of the content, body content, and key phrases. In aspects, determine operation 206 interprets HTML tags to generate the web content in a raw text form. Determine operation 206 further converts (i.e. featurizes) the web content in the raw text form into vector form that describes linguistic features of the web content.

Sources of information about the item may not be limited to the landing page of the item. Source of the information may be in other forms, a product database of a manufacturer or a service provider, for example.

Generate operation 208 generates the embedded form of the web content using an encoder portion of the deep learning model. In aspects, the encoder may be a pre-trained natural language representation model, Bidirectional Encoder Representations from Transformers (BERT) for example. The encoder may also be based on a robustly optimized BERT pre-training approach (RoBERTa), for example. Generate operation 208 outputs an embedded form of contexts with the web content (e.g., embedded content data 140 in FIG. 1). The embedded content data based on RoBERTa captures understanding of the web content. The web content represents accurate descriptions of the item (or organization or service). This way, the understanding of the item or the service may be used as a basis for the decoder portion of the deep learning model to build understanding of copy for the item as described in the web content.

Generate operation 210 generates one or more preliminary suggestions of copy (e.g., preliminary suggestions 144 of copy in FIG. 1). In aspects, generate operation 210 may use the decoder portion of the deep learning model to decode the embedded content data and generate each preliminary suggestion. The decoder may be based on Generative Pre-trained Transformer 2 (GPT-2), for example. GPT-2 uses auto-regressive, transformer decoder blocks to iteratively suggest subsequent words (or tokens) to accurately generate preliminary suggestions of copy for the item to be advertised.

In aspects, generate operation 210 generates preliminary suggestions based on real-time inference as interactive editing of copy takes place (e.g., in interactive copy design client 111). To improve the performance and meet the real-time inference, generate operation 210 may impose limitations on the extent of search operations on specific conditions (e.g., end of segment and a maximum number of tokens to search) during the decoding process. The search operations may be beam search operations to search for a next word, for example. The specific condition may include stopping the search operations at the end of segment or a maximum number of tokens to search, for example. Furthermore, a set of specific vectors, k and v vectors, for example, of the embedding data during the decoding process may be cached in a local memory for improving processing performance of copy decoder 132. In aspects, the modification for improvement of performance resulted in 4.1 times (e.g., from 31.16 seconds to 12.72 seconds) faster in generating a copy suggestion based on a single website. In other aspects, the improvement of real-time inference was 7 times (from 2100 milliseconds to 510 milliseconds) faster in generating 16 copy suggestions in a batch process, for example.

In aspects, the present disclosure is not limited to using the set of encoder and decoder for the deep learning model. Other combinations or technologies of a deep learning model may be used interchangeably. More than one deep learning model or natural language processing models may be aggregated in the present disclosure to generate suggestions of copy based on descriptions of an item or a service to be advertised.

Generate operation 212 generates suggestions of copy as a post-processing procedure. Generate operation 212 may comprise one or more steps to validate each of the one or more preliminary suggestions as output from the decoder of the deep learning model. Generate operation 212 may remove one or more preliminary suggestions that fail any one of the validations. FIG. 3A describes details of the validations as indicated by the “A” in a circle next to generate operation 212. In some aspects, generate operation 212 generates no suggestion of copy when all of the preliminary suggestions fail the validation, for example.

Provide operation 214 provides suggestions of copy. In aspects, provide operation 214 transmits the suggestions to interactive copy design client 111 over the network. A number of suggestions for transmission may be predetermined. When there is no suggestion for copy, provide operation 214 may provide an indication of “no suggestion” to interactive copy design client 111.

Receive operation 216 receives a text input for editing at last a portion of the copy. In aspects, the directed content provider 110 may start editing one of suggestions of copy using interactive copy design client 111. Receive operation 216 may receive one or more words as the text input as the directed content provider 110 types in text during the interactive editing of the copy. The received text input needs to be processed to generate a new suggestion of the copy in real-time. In some aspects, the web content decoder (e.g., copy decoder 132) of the deep learning model (e.g., deep learning model 128) may receive the received text (e.g., text input receiver 160).

Determine operation 218 determines a probability of the text input being valid at least as a part of copy. In particular, the probability is based on relevancy of one or more words of the text input against understanding of the web content and any existing suggestions of copy for the item. In some aspects, a translation process within the decoder includes decoding the one or more words from the text input to generate the probability (e.g., decoder replay). In some other aspects, determine operation 218 may determine whether the text input contains an expression that is offensive and inappropriate for use in copy. Decoder registers the inappropriate expression to prevent itself from using the inappropriate expression in generating preliminary suggestions. FIG. 3B describes more details of determine operation 218 as indicated by the “B” in a circle.

Once the text input is determined as being valid for use as a part of preliminary suggestions of copy, the operation proceeds to generate operation 210. This way, the deep learning model accommodates the text input in real-time to continue the decoding and the post-processing to update suggestions of copy. The real-time updates of suggestions enable interactive editing of the copy by directed content provider 110.

As should be appreciated, operations 202-218 are described for purposes of illustrating the present methods and systems and are not intended to limit the disclosure to a particular sequence of steps, e.g., steps may be performed in different order, an additional steps may be performed, and disclosed steps may be excluded without departing from the present disclosure.

FIGS. 3A-3B illustrate an example method of interactively providing suggestions on directed content according to aspects of the present disclosure. FIG. 3A illustrates an example method of post-processing to generate suggestions of copy according to aspects of the present disclosure. A general order of the operations for the method 300A is shown in FIG. 3A. Generally, the method 300A illustrates a sequence of operations for generate operation 212 (post-processing) of FIG. 2. The method 300A may include more or fewer steps or may arrange the order of the steps differently than those shown in FIG. 3A. The method 300A can be executed as a set of computer-executable instructions executed by a computer system and encoded or stored on a computer readable medium. Further, the method 300A can be performed by gates or circuits associated with a processor, an ASIC, an FPGA, a SOC or other hardware device. Hereinafter, the method 300A shall be explained with reference to the systems, components, devices, modules, software, data structures, data characteristic representations, signaling diagrams, methods, etc., described in conjunction with FIGS. 1, 2, 3B, 4, 5A-B, 6A-D, 7, 8A-B.

The post-processing comprises a series of steps for validating the preliminary suggestions. A preliminary suggestion that fails a validation may be removed and excluded from suggestion of copy. Remove operation 304 removes one or more preliminary suggestions based on disapproved words (i.e., editorial check). In aspects, words in the preliminary suggestions may be compared against a list of disapproved words. The disapproved words may be words that have been disapproved from use in copy because of offensiveness for example.

Remove operation 306 removes one or more preliminary suggestions when words in the one or more preliminary suggestions contradict facts described in the web content (i.e. data fact check). In aspects, remove operation 306 uses cached data of the web content (e.g., web content cache store 138 in FIG. 1) and a dictionary that contains tokens of a corpus of advertisement in general. Remove operation 306 ensures that copy suggestions do not contradict information in the directed content provider's URL, such as by making wrong promises that include terms “Free Shipping,” “Free Quote,” “Lowest Prices,” when the web content about the item does not contain such terms.

Remove operation 308 removes one or more preliminary suggestions when the one or more preliminary suggestions is not relevant to businesses of the directed content provider. In aspects, remove operation 308 uses a high-frequency token white list, which contains tokens (or words) that appear in a high frequency in the web content for the item. Such frequently used words are appropriate to be used in copy to advertise the item.

Remove operation 310 removes one or more preliminary suggestions when the one or more preliminary suggestions contain a grammatical issue. Capitalization of words may relate to the grammatical issue. Remove operation 310 may use an English language filter on the preliminary suggestions for example. Remove operation 310 may use a case dictionary for the web content (e.g., for the landing page 104A and/or the details page 104B), which is generated from web content cache store 138. The case dictionary contains correct case for each of the tokens in suggestions of copy. Remove operation 310 may also use the dictionary that contains tokens of a corpus of directed content in general. Use of the case dictionary may be used in priority over the token dictionary to provide suggestions that are consistent with descriptions of the item.

Generate operation 312 generates suggestions of copy based on the remaining preliminary suggestions. A maximum number of suggestions may be predetermined based on system configurations. The maximum number may be predetermined based on various factors, an overall processing time of generating the suggestions in response to receiving the text input, for example.

As should be appreciated, operations 302-312 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 3B illustrates an example method of processing the received text input during an interactive editing of a suggestion of copy according to aspects of the present disclosure. A general order of the operations for the method 300B is shown in FIG. 3B. Generally, the method 300B illustrates a sequence of operations for determine operation 218 of FIG. 2. The method 300B may include more or fewer steps or may arrange the order of the steps differently than those shown in FIG. 3B. The method 300B can be executed as a set of computer-executable instructions executed by a computer system and encoded or stored on a computer readable medium. Further, the method 300B can be performed by gates or circuits associated with a processor, an ASIC, an FPGA, a SOC or other hardware device. Hereinafter, the method 300B shall be explained with reference to the systems, components, devices, modules, software, data structures, data characteristic representations, signaling diagrams, methods, etc., described in conjunction with FIGS. 1, 2, 3A, 4, 5A-B, 6A-D, 7, 8A-B.

The method 300B starts with determine operation 342 that proceeds from receive operation 216 (shown as a step 340). Determine operation 342 determines probability of the text input being valid. The probability is based on relevancy of one or more words of the text input against understanding of the web content and any existing suggestions of copy for the item to be advertised. In some aspects, a translation process within the decoder includes decoding the one or more words from the text input to generate the probability (e.g., decoder replay). In some other aspects, determine operation 218 may determine whether the text input contains an expression that is offensive and inappropriate for use in copy. Decoder registers the inappropriate expression to prevent itself from using the inappropriate expression in generating preliminary suggestions.

Comparison operation 344 compares the probability of the text input and a predetermined threshold. When a value of the probability is greater than the predetermined threshold (i.e. YES 346), a determine operation 348 determines the text input as valid at least as a part of a preliminary suggestion of copy. Determine operation 348 proceeds to generate operation 210 (shown as a step 350).

When a value of the probability is not greater than the predetermined threshold (i.e. NO 352), the operation proceeds to provide operation 354. Provide operation 354 either provides an indication no suggestion of copy or provides no suggestion based on the text input. This way, copy generator 120 rejects, in real-time, a text input that is not suitable to be incorporated into suggestions and provides a feedback to the interactive copy design client 111 used by the directed content provider 110. This way, the directed content provider 110 may continue exploring other words during the interactive editing of copy.

As should be appreciated, operations 340-354 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

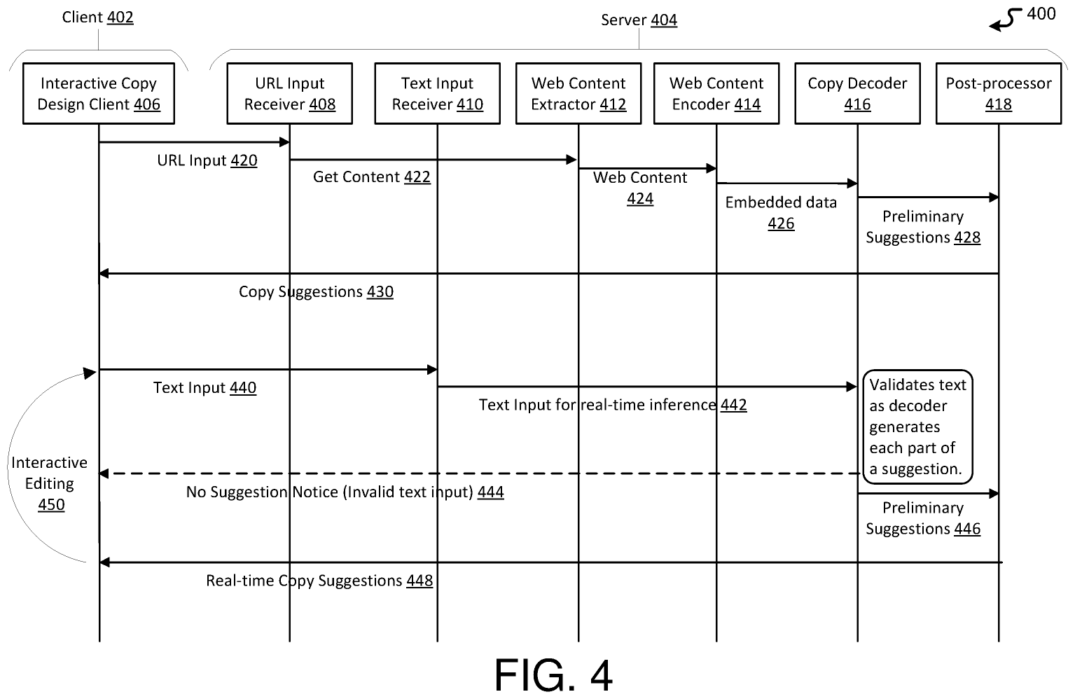

FIG. 4 illustrates an example flow for interactively providing suggestions on directed content in accordance with aspects of the present disclosure. FIG. 4 illustrates communication between client 402, which includes interactive copy design client (e.g., interactive copy design client 111 in FIG. 1) and server 404 (e.g., copy generator 120 in FIG. 1).

Upon receiving a URL data from the directed content provider 110, interactive copy design client 406 sends URL input 420 to URL input receiver 408 of server 404. URL input receiver 408 sends a command to web content extractor 412 to extract content of a web page (and/or a website) as specified by the URL input 420. Web content extractor 412 sends the extracted web content (e.g., in an HTML form) to web content encoder 414. Web content encoder is an encoder portion of the deep learning model. In some aspects, web content may be in a featurized form (e.g., a vector form of texts in the web content, featurized content data 142 in FIG. 1) before sending to web content encoder 414. Web content encoder 414 generates an embedded form of the web content to capture understanding of the web content in the deep learning model.

Web content encoder 414 sends the embedded data 426 to copy decoder 416, a decoder portion of the deep learning model. Copy decoder 416 decodes the embedded data 426 and generates a set of preliminary suggestions of copy.

Copy decoder 416 sends the preliminary suggestions 428 to post-processor 418. Post-processor 418 validates the preliminary suggestions of copy. Based on the validation, post-processor 418 generates a set of suggestions of copy.

Post-processor 418 sends the copy suggestions 430 to interactive copy design client 406 of client 402. Interactive copy design client 406 may display the suggestions to enable editing the suggestions of the copy. Interactive copy design client 406 may receive text input from the directed content provider (e.g., directed content provider 110 in FIG. 1) to edit one of the suggestions.

Interactive copy design client 406 sends a text input 440 as received to text input receiver 410 of server 404 (e.g., text input receiver 160 of copy generator 120 in FIG. 1). Text input receiver 410 sends text input for real-time inference 442 to copy decoder 416. Copy decoder 416 validates the text input as the decoder generates each part of text for a suggestion of copy. When copy decoder 416 determines that the text input is invalid for use as a part of copy, copy decoder 416 optionally sends a no suggestion notice 444 to interactive copy design client 406. The no suggestion notice indicates that the text input has been determined as invalid. When copy decoder 416 determines that the text input is valid for use in generating a preliminary suggestion of copy, copy decoder 416 generates (or updates) preliminary suggestions of copy based on a combination of the text input and the preliminary suggestions.

Copy decoder 416 sends the preliminary suggestions 446 to post-processor 418. Post-processor 418 validates the preliminary suggestions 446 to generate (or update) suggestions of copy. Post-processor 418 sends real-time copy suggestions 448 to interactive copy design client 406. Interactive copy design client 406 provides user interface for interactive editing of copy to the directed content provider through iterative process of interactive editing 450.

As should be appreciated, the various methods, components, attributes, etc., described with respect to FIG. 4 are not intended to limit the systems and methods to the particular attributes described. Accordingly, additional topology configurations may be used to practice the methods and systems herein and/or some attributes described may be excluded without departing from the methods and systems disclosed herein.

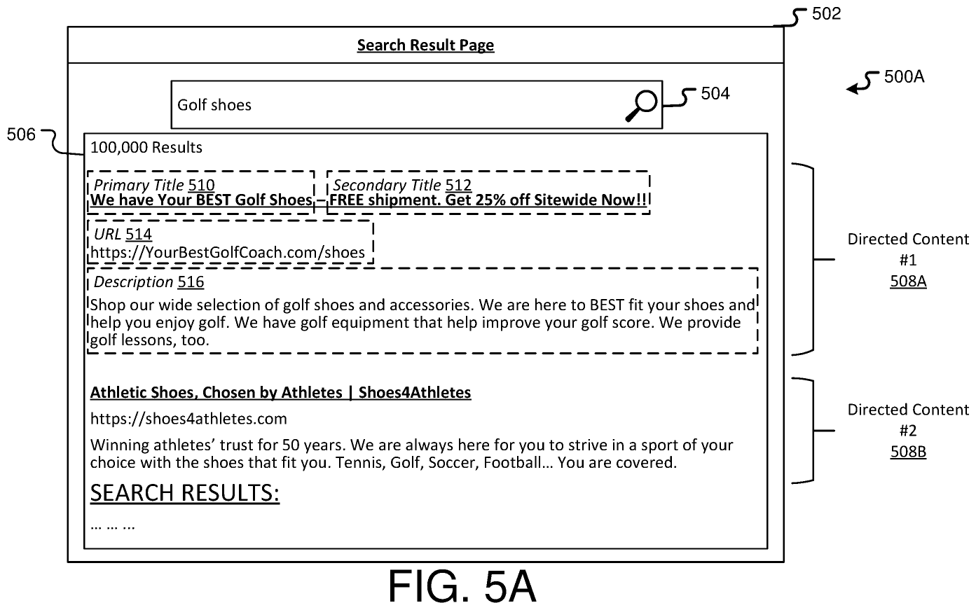

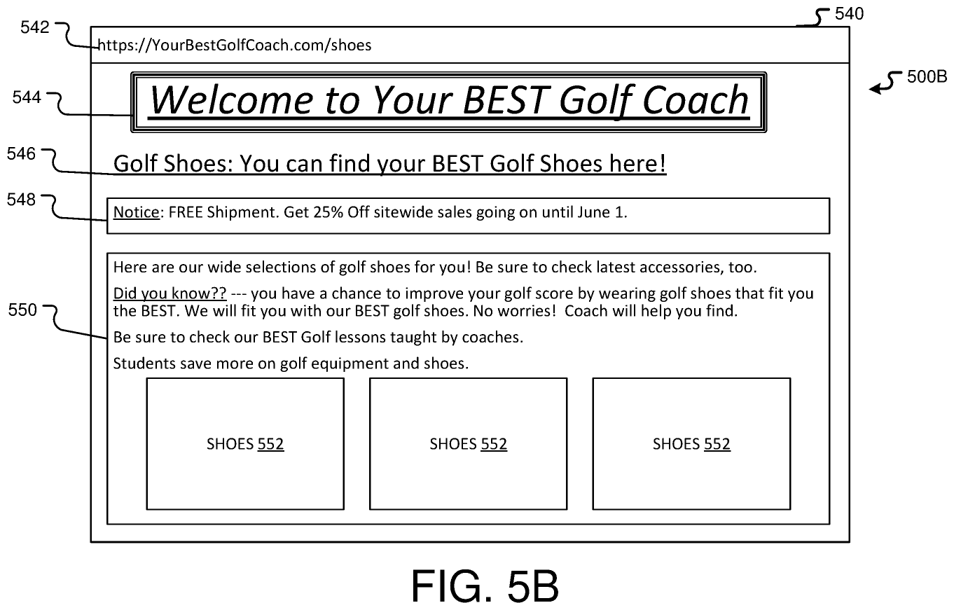

FIGS. 5A-B illustrate examples of screens of a web browser in accordance with aspects of the present disclosure. FIG. 5A illustrates an example of a search result page in accordance with aspects of the present disclosure. The search result page 500A comprises window 502. The window 502 indicates “Search Result Page” as its title. A search input field 504 displays a query input “Golf shoes,” indicating that the user (e.g., end user 108 in FIG. 1) intends to search for information about golf shoes. A search result section 506 displays results of the web search using the query input “Golf shoes.” In the example, the web search server (e.g., web search server 114 in FIG. 1) has found a total of 100,000 results based on the query. The search result section 506 lists two directed content pieces before the search result, for example.

Directed Content #1 508A comprises a primary title 510, a secondary title 512, URL 514, and a description 516. The primary title 510 indicates “We have Your BEST Golf Shoes.” The secondary title 512 indicates “FREE shipment. Get 25% off Site-wide Now!!” The URL 514 indicates https://YourBestGolfCoach.com/shoes. A description 516 indicates a short description of the golf shoes as an item being advertised: “Shop our wide selection of golf shoes and accessories. We are here to BEST fit your shoes and help you enjoy playing golf. We have golf equipment that help improve your golf score. We provide golf lessons, too.” Each of the primary title 510, the secondary title 512, and the description 516, are distinct pieces of copy. In aspects all the fields in an advertisement contain a link to a landing page for the golf shoes product. When the user selects any part of the advertisement #1, for example, the search result page takes the user to the landing page of the golf shoes at URL https://YourBestGolfCoach.com/shoes. FIG. 5 describes more details of the landing page.

Directed Content #2 508B describes another vendor product as golf shoes at Shoes4Atheletes. Advertisement #2 may have a structure that is similar to Advertisement #1 508A with different copy.

FIG. 5B illustrates an example of a landing page of an item in accordance with aspects of the present disclosure. In particular, FIG. 5B illustrates an example of a landing page for the golf shoes as advertised by the directed content #1 508A in FIG. 5A. The landing page 500B (e.g., landing page 104A) may be displayed in a window 540 that contains various fields. URL 542 indicates an URL of the landing page. Here the URL is shown as “https://YourBestGolfCoach.com/shoes.” The landing page has a title 544 “Welcome to your BEST Golf Coach.” A subtitle 546 indicates “Golf Shoes: You can find your BEST Golf Shoes here,” indicating that the web page is about its golf shoes product. Notice 548 describes an ongoing promotion and/or terms of selling the golf shoes product. Notice 548 indicates “FREE Shipment. Get 25% Off site wide. Sales going on until June 1.” Items field 550 includes sales pitch texts and descriptions of selling golf shoes. The items field 550 includes areas to display its golf shoes products: shoes 552. In aspects, the landing page may receive a selection input of a golf shoes for purchase.

As should be appreciated, the various methods, components, attributes, etc., described with respect to FIGS. 5A-B are not intended to limit the systems and methods to the particular attributes described. Accordingly, additional topology configurations may be used to practice the methods and systems herein and/or some attributes described may be excluded without departing from the methods and systems disclosed herein.

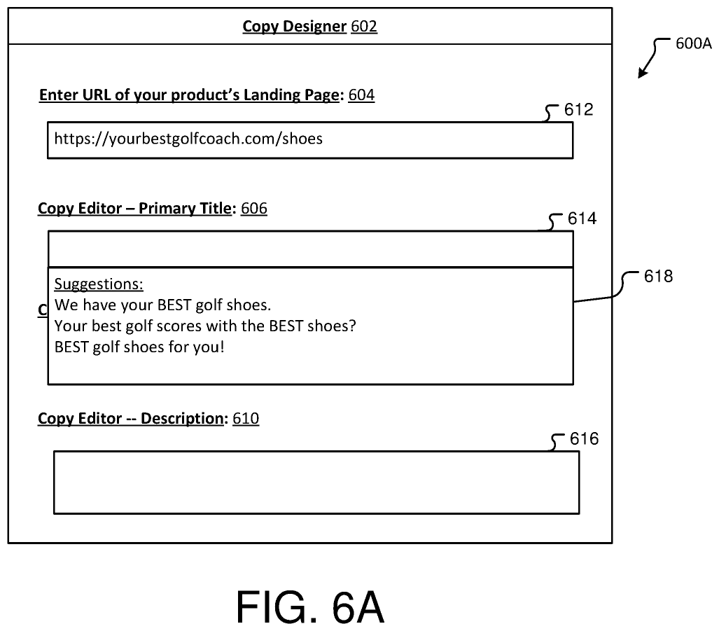

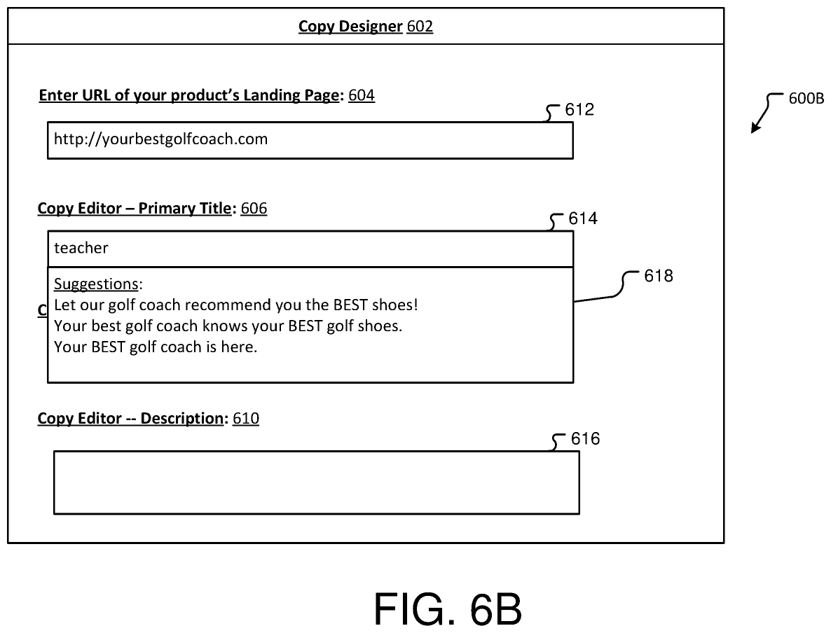

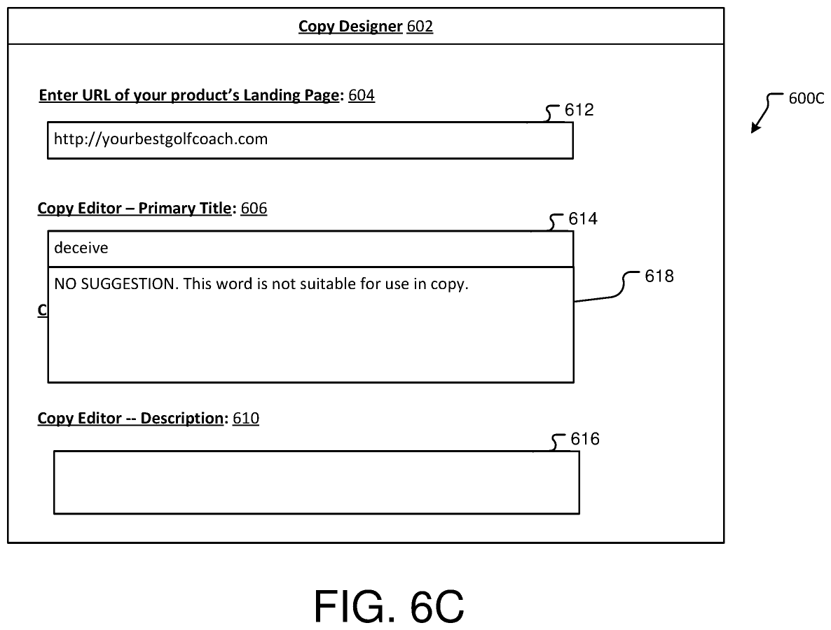

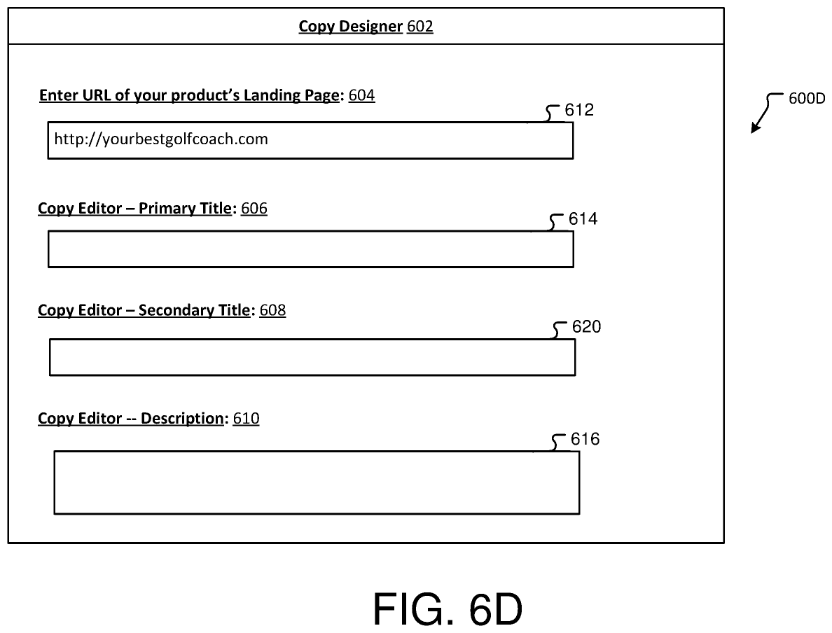

FIGS. 6A-D illustrate examples of an interactive copy design client in accordance with aspects of the present disclosure. FIG. 6A illustrates an exemplar screen 600A of an interactive copy designer (e.g. interactive copy design client 111 in FIG. 1). Copy Designer 602 provides an interactive user interface to receive URL input and to provide suggestions of copy for a directed content. A URL instruction section 604 instructs the user (e.g., directed content provider 110 in FIG. 1) to input a URL of a website, a landing page for example, of an organization, an item, or a service for which the directed content is being created. URL input field 612 indicates a URL of a landing page of a golf shoes product, for example: https://yourbestgolfcoach.com. There are three pieces of copy for this directed content: a primary title, a secondary title, and description. The primary title may be displayed as a primary title 510 in FIG. 5A. The secondary title may be displayed as a secondary title 512 in FIG. 5A. Description may be displayed under description 516 in FIG. 5 within a directed content. In aspects, recommendations may be displayed when the user selects a text input field that corresponds to a specific copy.

Once the URL is entered, the interactive copy client transmits the URL to copy generator (e.g. copy generator 120 in FIG. 1) in the server. Copy generator processes the URL to extract web content from the landing page of the golf shoes product, uses the deep learning model to embed the web content, decode and generate suggestions of copy. The interactive copy client receives the suggestions and displays the suggestions in pulldown menu 618 under primary title 606 (indicating “Copy Editor—Primary Title”). Pulldown menu 618 displays three suggestions of a copy for the primary title of the directed content: “We have your BEST golf shoes,” “Your best golf scores with the BEST shoes,” “BEST golf shoes for you!” In aspects, the suggestions may be displayed after the URL is entered and before any text is entered in the text input field 614 to start editing the copy. At least one of the suggestions of copy may be selected for further designing the copy. In some aspects a maximum number of suggestions may be predetermined by the user. Additionally or alternatively the maximum number of suggestions may be dynamically set based on a response time to generate suggestions in real-time in response to a received URL.

In aspects, copy generator 120 may store web content of web pages (or landing pages) that web content extractor 124 has recently extracted web content by web crawling. The process of extracting web content through web crawling over the network may be time consuming. The extracted web content may be stored in web content cache store 138 for example. This way, copy generator 120 can skip the process of extracting web content of a landing page and generate suggestions based on data in the web content cache store 138.

FIG. 6B illustrates an exemplar screen 600B of an interactive copy designer (e.g., interactive copy design client 111 in FIG. 1). In particular the exemplar screen 600B depicts an interactive editing of copy. The URL input field 612 indicates a URL of the web page (or the landing page 104A) of the item for which copy is designed. The text input field 614 under the primary title 606 indicates a word “teacher” as a text input during the interactive editing operations of the copy for the primary title. Pulldown menu 618 lists three suggestions of copy based on the word “teacher” and understanding about the golf shoes and the copy for the item. Accordingly, pulldown menu 618 lists three suggestions of the copy: “Let our golf coach recommend you the BEST shoes,” “Your best golf coach knows your BEST golf shoes,” and “Your BEST golf coach is here.” The copy generator 120 generates and provides the three suggestions in real-time as a response to the user entering the word “teacher.” In aspects, the decoder (e.g., copy decoder 132) in the deep learning model validated the word “teacher.” The decoder updates suggestions of copy in a real-time by inferring a coach from the word “teacher.” The three candidates contain the word “coach.”

In some aspects, suggestions of the copy may be generated to complete the copy using the text input as a part of the suggestion of the copy. When the text input is “best shoes,” a suggestion of the copy may be “BEST shoes for golf!,” “BEST shoes to play golf,” “BEST shoes available here for golf!.” This way, the suggestions of the copy may be provided to the interactive copy designer (e.g., interactive copy design client 111 in FIG. 1) to interactively auto-complete the copy based on the text input.

In some aspects, suggestions of the copy may be generated only for copy that the interactive editing operation of the copy takes place. The pulldown menu appears for the copy that the advertiser modifies in the text input field 614. By focusing on processing suggestion of specific copy, copy generator may improve its performance of updating suggestions of copy in response to received user input to modify the copy.

FIG. 6C illustrates an exemplar screen 600C of an interactive copy designer (e.g. interactive copy design client 111 in FIG. 1). In particular, the exemplar screen 600C depicts a situation when copy generator determines not to provide any suggestion to a text input during the interactive editing of copy. The text input is determined as invalid for use in copy, for example. In the exemplar screen 600C, the text input field 614 to edit copy for the primary title 606 shows a word “deceive.” After receiving the word “deceive” as a text input by the text input receiver (e.g., Text Input Receiver 160 in FIG. 1), the decoder has determined probability of the word “deceive” as being valid based on how the word appears in web content of the landing page (i.e. the web page as specified by a URL in the URL input field 612) and suggestions that have been generated. The suggestions may include the total of six suggestions as displayed in FIGS. 6A and 6B. Here, the decoder has determined that the probability is below a predetermined threshold. In some aspects, post-processor may use a dictionary of words that are deemed inappropriate for use in copy because of offending nature. The word “deceive” may be in the dictionary, for example. Accordingly, the suggestion provider (e.g., Suggestion Provider 136) has transmitted a no suggestion notice. Pulldown menu 618 indicates a message “NO SUGGESTION. This word is not suitable for use in copy.”

FIG. 6D illustrates an exemplar screen 600D of an interactive copy designer (e.g., interactive ad design client 111 in FIG. 1). In some aspects, there may be more than one type of copy: a primary title, a secondary title, and a description, for example. The exemplar screen 600D comprises a URL instruction section 604, URL input field 612, a section for designing primary title 606, a text input field 614 for designing the primary title, a section for designing secondary title 608 and a corresponding text input field 620 for designing the secondary title, a section for interactively editing a description 610 and its corresponding text input field to interactively design the description 616. In particular, the exemplar screen 600D shows only the URL input field 612 filled in by the user. To provide interactive user interface to edit copy, one or more optimizations may be implemented to improve speed of processing to provide suggestions of copy in real time. In some aspects, the interactive copy designer may limit displaying suggestions of copy to the pulldown menu that the user has selected on a specific copy. Suggestions for copy for secondary title 608 may displayed when the user selects secondary title input field 620 under secondary title 608, for example. This way, copy generator may focus on generating and updating suggestions for a specific piece of copy at a time. In some other aspects, the copy generator may continue updating suggestions and transmit suggestions for all copy. In yet some other aspects, the interactive copy designer may prefetch suggestions of copy for a plurality of copy input fields, a primary title, a secondary title, and descriptions, for example.

In some aspects, copy designer 602 may receive a portion of a word in respective text input fields. The copy designer 602 may estimate and provide remaining characters to auto-complete the word that the user is entering. The copy designer 602 may transmit the complete word to the copy generator to update suggestions as appropriate based on the complete word.

As should be appreciated, the various methods, components, attributes, etc., described with respect to FIGS. 6A-D are not intended to limit the systems and methods to the particular attributes described. Accordingly, additional topology configurations may be used to practice the methods and systems herein and/or some attributes described may be excluded without departing from the methods and systems disclosed herein.

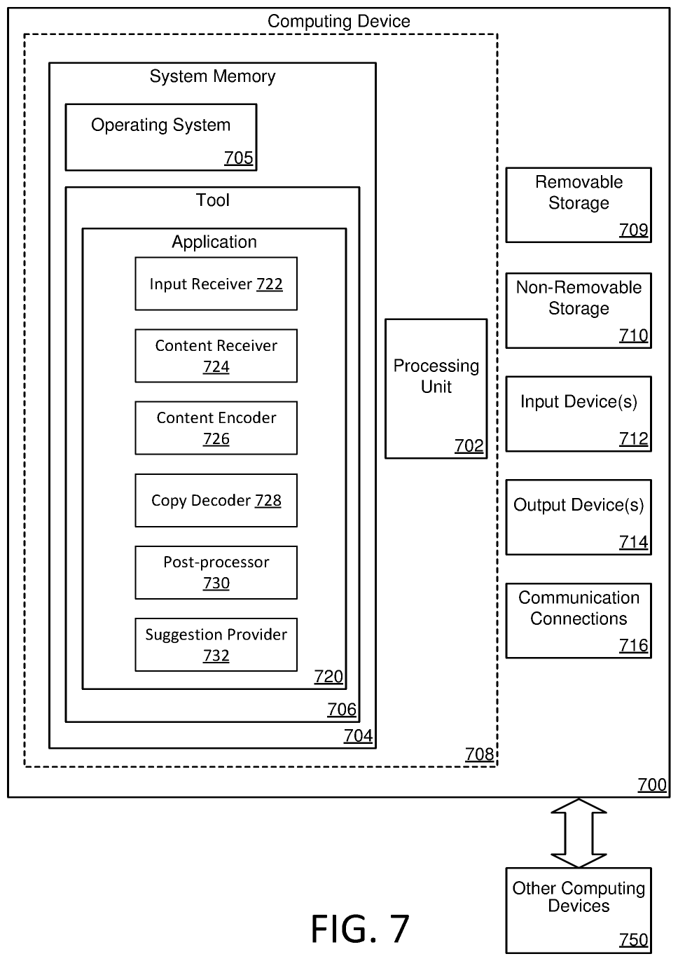

FIG. 7 is a block diagram illustrating physical components (e.g., hardware) of a computing device 700 with which aspects of the disclosure may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program tools 706 suitable for performing the various aspects disclosed herein such. The operating system 705, for example, may be suitable for controlling the operation of the computing device 700. Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program tools and data files may be stored in the system memory 704. While executing on the processing unit 702, the program tools 706 (e.g., copy generation application 720) may perform processes including, but not limited to, the aspects, as described herein. The copy generation application 720 includes an input receiver 722, a (web) content receiver 724, a (web) content encoder 726, a copy decoder 728, a post-processor 730, and a suggestion provider 732, as described in more detail with regard to FIG. 1. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 700 may also have one or more input device(s) 712, such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

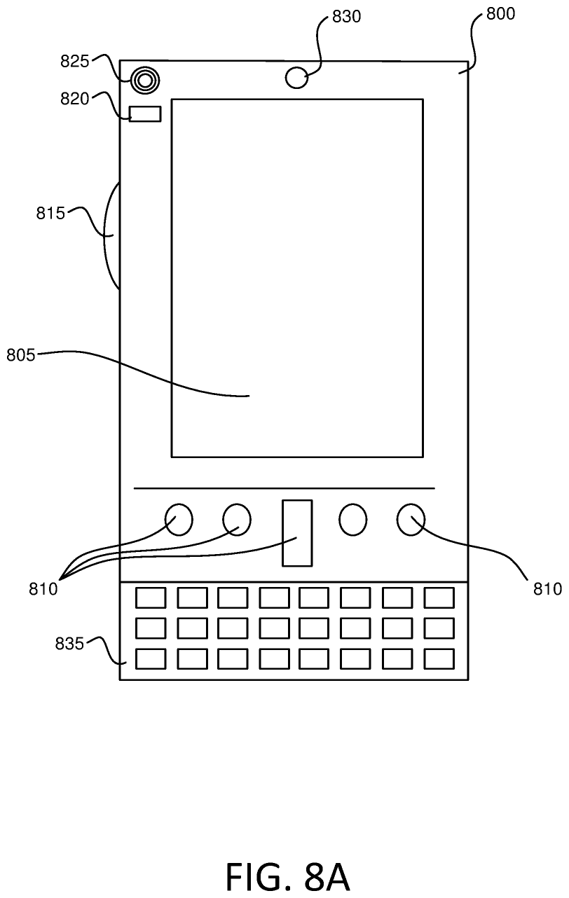

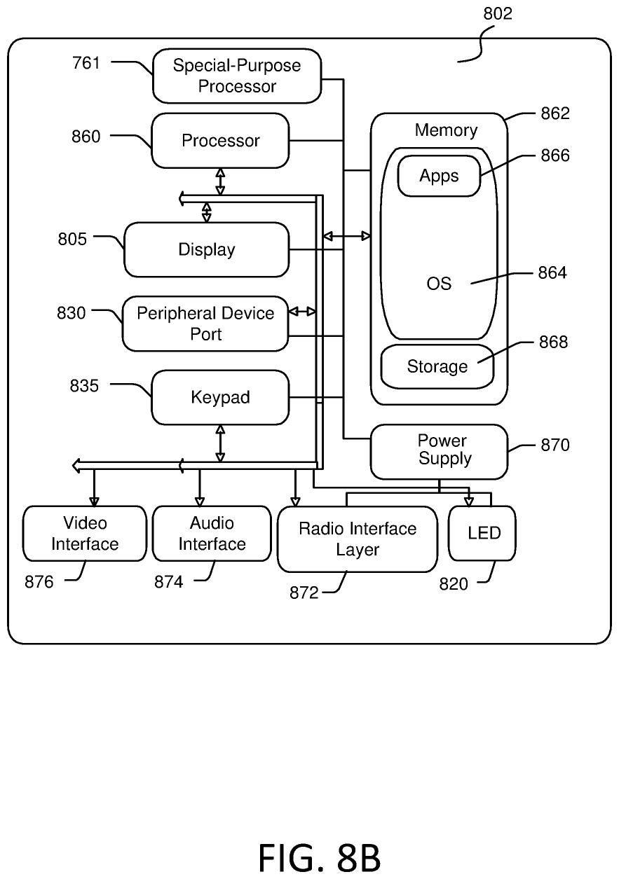

FIGS. 8A and 8B illustrate a computing device or mobile computing device 800, for example, a mobile telephone, a smart phone, wearable computer (such as a smart watch), a tablet computer, a laptop computer, and the like, with which aspects of the disclosure may be practiced. In some aspects, the client utilized by a user (e.g., end user 108 and directed content provider 110 in FIG. 1) may be a mobile computing device. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included as an optional input element, a side input element 815 allows further user input. The side input element 815 may be a rotary switch, a button, or any other type of manual input element. In alternative aspects, mobile computing device 800 may incorporate more or less input elements. For example, the display 805 may not be a touch screen in some aspects. In yet another alternative aspect, the mobile computing device 800 is a portable phone system, such as a cellular phone. The mobile computing device 800 may also include an optional keypad 835. Optional keypad 835 may be a physical keypad or a “soft” keypad generated on the touch screen display. In various aspects, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of computing device, a server (e.g., web server 102, web search server 114, and copy generator 120 in FIG. 1), a mobile computing device, etc. That is, the mobile computing device 800 can incorporate a system 802 (e.g., a system architecture) to implement some aspects. The system 802 can implemented as a “smart phone” capable of running one or more applications (e.g., browser, e-mail, calendaring, contact managers, messaging clients, games, and media clients/players). In some aspects, the system 802 is integrated as a computing device, such as an integrated digital assistant (PDA) and wireless phone.

One or more application programs 866 may be loaded into the memory 862 and run on or in association with the operating system 864. Examples of the application programs include phone dialer programs, e-mail programs, information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein.

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 (e.g., LED) may be used to provide visual notifications, and/or an audio interface 874 may be used for producing audible notifications via the audio transducer 825. In the illustrated configuration, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

As will be understood from the foregoing disclosure, one aspect of the technology relates to a computer-implemented method of generating a copy suggestion for directed content for a website. The method comprises generating a preliminary copy suggestion based on a deep learning model, wherein the deep learning model is generated using content of the website. Additionally, the method includes receiving an input from a user to be included in the directed content; modifying the preliminary copy suggestion based on the input from the user and the deep learning model to generate a modified copy suggestion. Additionally, the method includes validating the modified copy suggestion. When the modified copy suggestion is valid, the method includes providing the modified copy suggestion to the user.

Another aspect of the technology relates to a system. The system includes a processor and a memory storing computer-executable instructions that when executed by the processor cause the system to perform operations. The operations include generating a preliminary copy suggestion based on a deep learning model and content of a website. Additionally, the operations include receiving an input from a user for copy for the directed content and modifying the preliminary copy suggestion based on the input from the user and the deep learning model to generate a modified copy suggestion. The operations further include validating the modified copy suggestion. When the modified copy suggestion is valid, the operation includes providing the modified copy suggestion to the user.

In still further aspects, the technology relates to a computer-implemented method for interactively designing copy of a directed content. The method comprises receiving location information of a website through an interactive user interface. Additionally, the method includes providing, by the interactive user interface, a first copy suggestion for the directed content, wherein the first copy suggestion is based at least on a content of the website. The method further includes receiving a user input to modify at least a part of the first copy suggestion through the interactive user interface. The method yet further includes providing in real-time, by the interactive user interface, a second copy suggestion for the directed content based on the user input and the content of the website.

Any of the one or more above aspects in combination with any other of the one or more aspect. Any of the one or more aspects as described herein.

1. A computer-implemented method of generating a copy suggestion for directed content for a website, the method comprising:
automatically generating, by a server, a preliminary copy suggestion based at least on an embedded form of the web content in a deep learning model, wherein the deep learning model is includes a combination of encoding and decoding of a featurized form of content of the website;
interactively receiving, by the sever, an input from a user to be included in the directed content;
iteratively modifying, by the server, the preliminary copy suggestion based on a combination of the input from the user and use of the deep learning model to generate a modified copy suggestion;
validating the modified copy suggestion; and
when the modified copy suggestion is valid, providing the modified copy suggestion for the directed content for the website to the user.

2. The computer-implemented method of claim 1, the method further comprising:
generating a plurality of preliminary copy suggestions based on the deep learning model and content of the website;
receiving a selection, from the user, of a first preliminary copy suggestion of the plurality of preliminary copy suggestions; and
modifying the first preliminary copy suggestion based on the user input and the deep learning model to generate the modified copy suggestion.

3. The computer-implemented method of claim 1, the method further comprising:
extracting the content of the website using web crawling;
encoding the extracted content with embedding contexts of the extracted content in the deep learning model;
decoding a preliminary copy suggestion based on the encoded content; and
generating the copy suggestion based on the preliminary copy suggestion.

4. The computer-implemented method of claim 1, wherein validating the modified copy suggestion further comprises:
determining that the modified copy suggestion is invalid when one or more words in the modified copy suggestion match a word in a dictionary of disapproved words.

5. The computer-implemented method of claim 1, wherein validating the modified copy suggestion further comprises:
determining that the modified copy suggestion is invalid when the modified copy suggestion contradicts the content of the website.

6. The computer-implemented method of claim 1, wherein validating the modified copy suggestion further comprises:
determining that the modified copy suggestion is invalid when the modified copy suggestion is irrelevant to a context of the content of the website.

7. The computer-implemented method of claim 1, wherein validating the modified copy suggestion further comprises:
determining that the modified copy suggestion is invalid when the modified copy suggestion fails to meet a grammar requirement.

8. The computer-implemented method of claim 1, the method further comprising:
determining whether to reject the received input from the user based on the deep learning model; and
providing a notice to the user when it is determined to reject the received input from the user.

9. The computer-implemented method of claim 1, wherein the deep learning model comprises an encoder and a decoder, the encoder encoding an embedded form of contexts with the content of the website, and the decoder decoding encoded copy for generating the copy suggestion.

10. A system, comprising:
a processor; and
a memory storing computer-executable instructions that when executed by the processor cause the system to:
automatically generate, by a server, a preliminary copy suggestion based at least on an embedded form of the web content in a deep learning model and content of a website, wherein the deep learning model includes at least encoding in a featurized form of content of the website;
interactively receive, by the sever, an input from a user for copy for the directed content;
iteratively modify, by the server, the preliminary copy suggestion based on a combination of the input from the user and use of the deep learning model to generate a modified copy suggestion;
validate the modified copy suggestion; and
when the modified copy suggestion is valid, provide the modified copy suggestion for the directed content for the website to the user.

11. The system of claim 10, the computer-executable instructions when executed further causing the system to:
generate a plurality of preliminary copy suggestions based on the deep learning model and content of the website;
receive a selection, from the user, of a first preliminary copy suggestion of the plurality of preliminary copy suggestions; and
modify the first preliminary copy suggestion based on the user input and the deep learning model to generate the modified copy suggestion.

12. The system of claim 10, the computer-executable instructions when executed further causing the system to:
extract the content of the website;
encode the extracted content with embedding contexts of the extracted content in the deep learning model;
decode a preliminary copy suggestion based on the encoded content; and
generate the copy suggestion based on the preliminary copy suggestion.

13. The system of claim 10, the computer-executable instructions when executed further causing the system to:
determine that the modified copy suggestion is invalid when one or more words in the modified copy suggestion match a word in a dictionary of disapproved words.

14. The system of claim 10, the computer-executable instructions when executed further causing the system to:
determine that the modified copy suggestion is invalid when the modified copy suggestion contradicts the content of the website.

15. The system of claim 10, the computer-executable instructions when executed further causing the system to:
modify in real-time the preliminary copy suggestion based on the input from the user and the deep learning model.

16. The system of claim 10, the computer-executable instructions when executed further causing the system to:
validate the modified copy suggestion in real-time.

17. A computer-implemented method for interactively designing copy of a directed content, the method comprising:
receiving, by a server, location information of a website through an interactive user interface;
automatically providing, by the server through the interactive user interface, a first copy suggestion for the directed content, wherein the first copy suggestion is based at least on an embedded form of content of the website using a deep learning model;
interactively receiving, by the server, a user input to modify at least a part of the first copy suggestion through the interactive user interface; and
iteratively providing in real-time, by the interactive user interface, a second copy suggestion for the directed content for the website based on the user input and the content of the website.

18. The computer-implemented method of claim 17, wherein the directed content is an advertisement.

19. The computer-implemented method of claim 17, the method further comprising:
receiving a notification indicating no copy suggestion is available based on the user input.

20. The computer-implemented method of claim 17 wherein the user input is a word.
